(19) United States
(12) Patent Application Publication
(10) Pub. No.: US 2010/0107490 A1
(43) Pub. Date: May 6, 2010

(54) GUIDE AND FASTENING ELEMENT TO FORCE THE VERTICAL GROWTH OF THE STOCKS OF A VINE

(75) Inventor: Ángel Ricardo Martin Alvarez, La Rioja (ES)

Correspondence Address: IP Patent Docketing;K&L GATES LLP, 599 Lexington Avenue, 33rd Floor, New York, NY, 10022-6030, US

(73) Assignees: Juan Carlos Martin Alvarez, Lardero, La Rioja (ES); Jose Antonio Martin Alvarez, Lardero, La Rioja (ES)

(21) Appl. No.: 12/524,231

(22) PCT Filed: Dec. 20, 2007
(86) PCT No.: PCT/ES2007/070215

§ 371 Date: Dec. 28, 2009

(30) Foreign Application Priority Data
Jan. 23, 2007 (ES) U 200700136

(51) Int. Cl. A01G 17/06

(52) U.S. Cl. 47/46

(57) ABSTRACT

A guide and fastening element is used to draw together and keep joined together the cables which guide the stocks and which force their vertical growth. The stocks may be confined to the space between said cables, and that it is formed by a warped structure made with wire in a rigid material which has two branches in the common vertex whereof an elastic element is disposed, each branch being bent by one or more points forming different stretches and the free end of each branch having a hooking element in order to hold the cable of the opposite side of a post of the vine.

### CROSS-REFERENCES TO RELATED APPLICATIONS

This application claims the benefit under 35 U.S.C. §371 to PCT/ES2007/070215 filed Dec. 20, 2007, which claims the benefit of Spanish Utility Model Application 0200700136 filed Jan. 23, 2007 in Spain. The entire disclosures of said applications are incorporated herein by reference thereto.

### BACKGROUND

Some vine guide devices guide the branches of the vine stocks to force the vine stocks vertical growth and thus avoid the vines branching off to the sides. These vine guide devices generally use lines of posts aligned according to the direction of the furrows formed by the stocks and which go from one end of the vine to the other. On both sides of these posts and fastened to the two posts of the ends and to an intermediate one, wires run horizontally at several different heights. Elements are fixed to each of the two sides of each post. These elements purpose is to keep the aforementioned pairs of wires joined together and also to keep them from separating. In this way, when the stock branches reach increasing heights, these devices enclose them, forcing them to continue growing vertically, limited to the space between each pair of wires.

### BRIEF DESCRIPTION OF THE DRAWINGS

For the purpose of complementing this description and helping to better understand the example embodiments disclosed herein, a set of drawings in accordance with some particular example embodiments has been included as an integral part of this specification, wherein the following have been represented in an illustrative and non-limiting manner:

FIG. 1 shows two example guides used on a line of posts, according to an example embodiment of the present invention.

FIG. 2 illustrates an example guide in an open position, according to an example embodiment of the present invention.

FIG. 3 illustrates an example guide in a closed position, according to an example embodiment of the present invention.

FIGS. 4, 5 and 6 illustrate other example guides, according to example embodiments of the present invention.

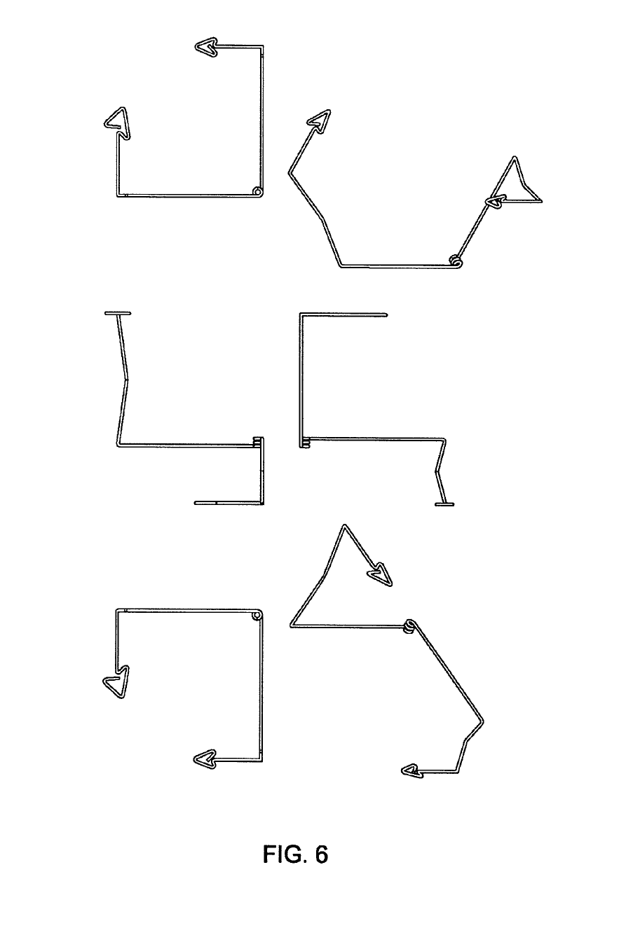

### DETAILED DESCRIPTION OF EXAMPLE EMBODIMENTS

The spatial direction of the joints between the posts and the elements which keep the cables joined together has been, to date, perpendicular to the lines of posts. This joining is generally performed by using fork nails. A drawback entailed by this joint is the ease with which the nail comes out, due to possible collisions with the automatic harvester machines. The automatic harvester machine circulates through the vine furrows, between the lines of posts and, therefore, may hit the nails that are facing the sides of the machine. In addition leaving the guide device out of service, these detached nails occasionally reach the hydraulic grape press and may damage its membranes, causing a serious fault

Some example embodiments of the present invention include guides to force the vertical growth of the stocks of a vine. One advantageous feature of some of these guides is that they does not interfere with the automatic collection of grapes. In one example embodiment of the present invention, a guide and a fastening element may be used to draw together and keep joined together the cables which guide the stocks and which force their vertical growth. The stocks are confined to the space between said cables. The guides may be a warped structure made with wire in a rigid material which has two branches in the common vertex where an elastic element is disposed. Each branch may be bent by one or more points forming different stretches and the free end of each branch having a hooking element, in order to hold the cable of the opposite side of a post of the vine.

In one example embodiment, the wire may be manufactured from any rigid material, such as any plastic, polymeric or metallic material, for example.

In an alternative example embodiment, the wire many be manufactured from stainless steel.

In the present document, it is understood that a structure is warped when it is not contained in one plane.

In order to improve clarity, branch is the name given to each of the parts of the guide found on either sides of the elastic element and which meet at the elastic element and are joined at the opposite end when the guide is fastened. In turn, a stretch is each one of the divisions of a branch, including a segment of wire, bent in at least one of its ends.

An elastic element may be any element or device, for example, a torsion spring, which, when the branches meeting therein are separated or drawn together, exercises a force in the opposite direction to the separation or drawing together, called recovery force.

In accordance with another example embodiment, the elastic element is a torsion spring.

Furthermore, hooking element is also understood to mean any device that can be used to fasten the cable of the other end of the post, by way of hook or catch, among others.

In one example embodiment, the hooking element has the form of an arrow head.

Various example embodiments are based on the element's own morphology. In one example embodiment, a coiled torsion spring is positioned in the center of the guide. In one embodiment, the spring orifice may house a screw, with which the guide may be joined to the stock at a joint. The joint may be in the same direction as the lines of posts, so that the screw is protected from colliding with the harvester, thereby avoiding the guide being separated from the posts. In this way, by positioning the elements at different heights on the posts, the shoots are guided in their growth in successive seasons.

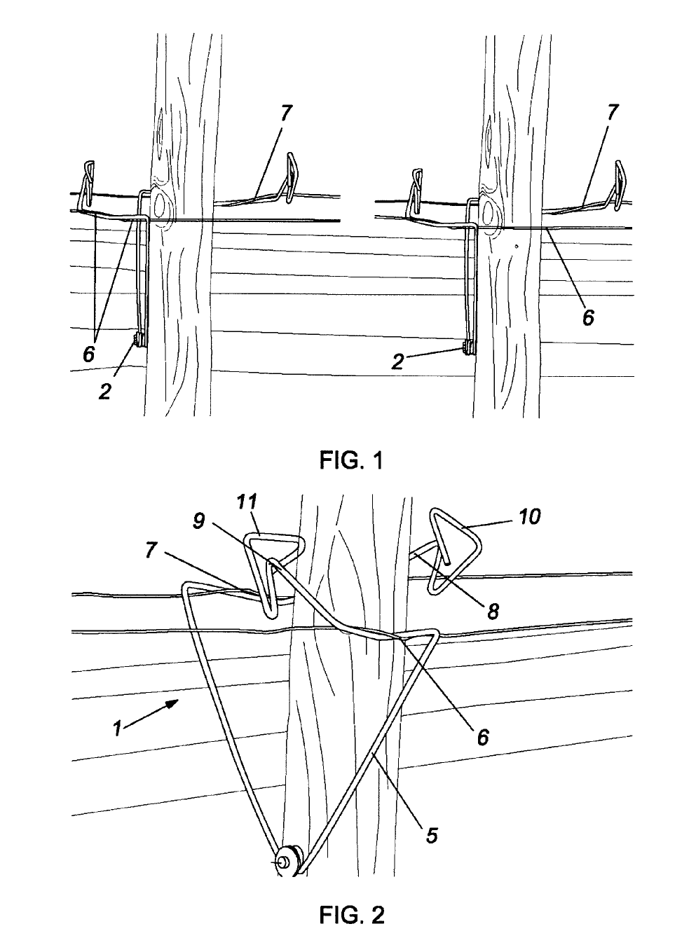

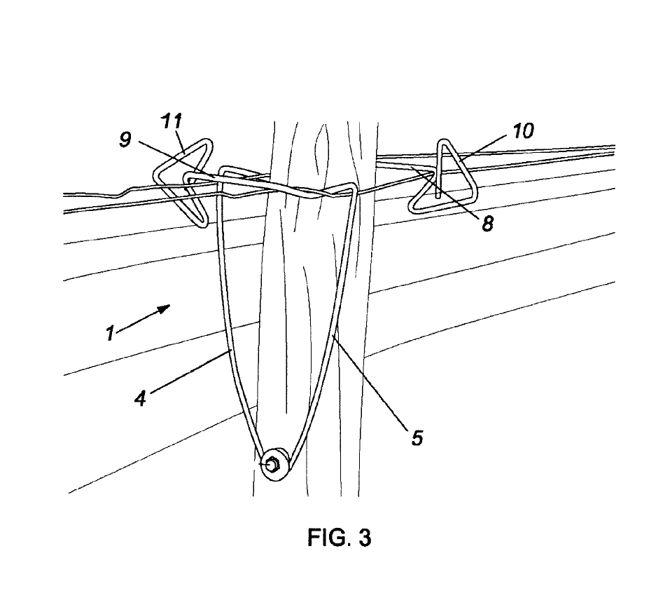

Referring to FIGS. 1 and 2, in various embodiments a guide 1 may be formed by bending a wire made of a rigid material. A coil 2 may form a torsion spring, for example. In the cavity formed by the coil 2 on being wound, a screw, rivet, bolt or the like is housed to fix the guide to the post. After the joint, stretches 4 and 5 form a vertical plane tangential to the post at the joining point. Stretches 6 and 7, slightly bent, are not contained in the plane defined by 4 and 5 and serve to hook the cable that remains on that side of the post. Stretches 8 and 9, which end in the hooks 10 and 11, serve to fasten the cable positioned on the opposite side of the post and attract it towards their side. In FIG. 1, two adjacent posts of the same line according to one embodiment are illustrated. The guide 1 is protected by the post from collisions with the automatic harvester.

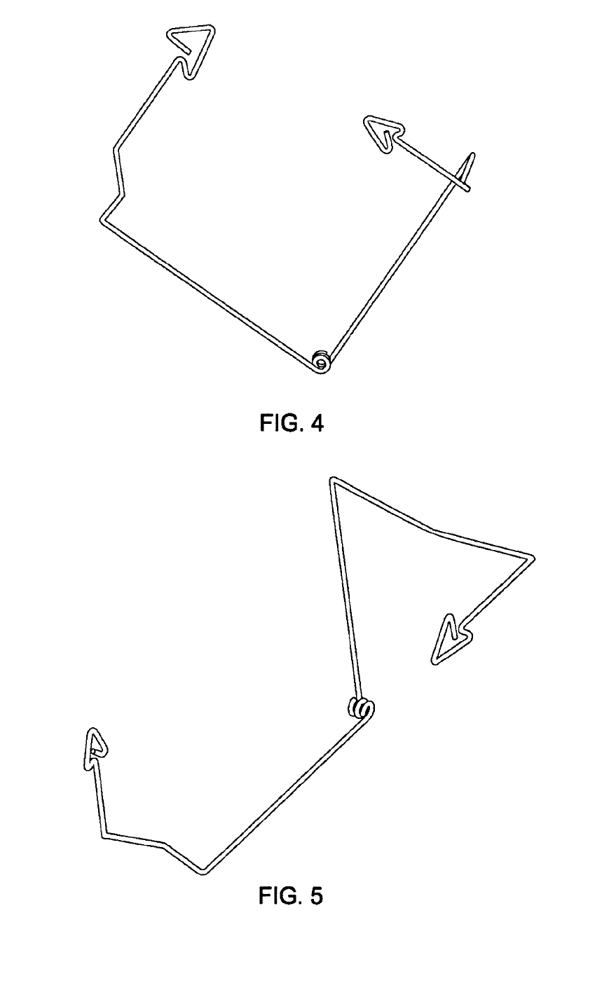

The guide 1 has at least two operating positions. FIG. 2 shows one example embodiment in the winter position, which is an open position. In this position, the coil 2 is relaxed relative to FIG. 3. In this embodiment illustrated in FIG. 2, each cable of the post is only held by stretches 4 and 5. FIG. 3 shows the example embodiment in the spring position, which is a closed position. In this position, the coil 2 is providing a tensioning force. In this embodiment, the hooks 10 and 11 are already fastening the cable of the opposite side. In the closed position the cables are closer together and enclose the shoots. Thus, the shoots grow inside the space limited by the cables and, on bringing them together, they are guided in their growth so that they grow vertically.

Having sufficiently described the nature of the various example embodiments, it should be stated that the aforementioned devices and those represented in the drawings may have their details modified provided it does not alter the fundamental principle.

The embodiments are, of course, not limited to the examples described but covers all the variants defined in the claims. The terms “a” and “an” and “the” and similar referents used in the context of the following claims are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the embodiments and does not pose a limitation on the scope of the embodiments otherwise claimed. No language in the specification should be construed as indicating any non-claimed element essential to the practice of the embodiments.

The use of the term “or” in the claims is used to mean “and/or” unless explicitly indicated to refer to alternatives only or the alternatives are mutually exclusive, although the disclosure supports a definition that refers to only alternatives and “and/or.” Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments are described herein, including the best mode known to the inventors for carrying out the invention. Of course, variations on those preferred embodiments will become apparent to those of ordinary skill in the art upon reading the foregoing description. The inventor expects those of ordinary skill in the art to employ such variations as appropriate, and the inventors intend for the embodiments to be practiced otherwise than specifically described herein. Accordingly, these embodiments include all modifications and equivalents of the subject matter recited in the claims appended hereto as permitted by applicable law. Moreover, any combination of the above-described elements in all possible variations thereof are encompassed by the embodiments unless otherwise indicated herein or otherwise clearly contradicted by context.

Further, it is to be understood that the example embodiments disclosed herein are illustrative. Other modifications that may be employed are within the scope of the embodiments. Thus, by way of example, but not of limitation, alternative configurations of the present embodiments may be utilized in accordance with the teachings herein. Accordingly, the present embodiments are not limited to that precisely as shown and described in the specification and drawings.

1-5. (canceled)

6. A vine guide attachment apparatus, comprising:
a first branch, wherein the first branch has at least one bend forming a first stretch, and wherein the first branch has a first free end having a first hook configured to a engage a supporting cable;
a second branch, wherein the second branch has at least one bend forming a second stretch, and wherein the second branch has a second free end having a second hook configured to engage a second supporting cable;
a coil disposed at a vertex of the first branch and the second branch.

7. The apparatus of claim 1, wherein the guide is manufactured from material selected from the group consisting of a metallic material, a ceramic material and a plastic material.

8. The apparatus of claim 7, wherein the guide is stainless steel.

9. The apparatus of claim 1, wherein the coil is a torsion spring configured to provide a force drawing the supporting cable and the second supporting cable together when the first branch is engaged with the supporting cable and the second branch is engaged with the second supporting cable.

10. The apparatus of claim 1, wherein the first hook is an arrowhead shape and the second hook is an arrowhead shape.

11. The apparatus of claim 1, wherein the guide comprises a wire.

12. The apparatus of claim 1, wherein the coil is configured to receive a fastener attaching the apparatus to a post.

13. The apparatus of claim 12, wherein the fastener is a screw.

14. A vine support structure, comprising:
a row of posts;
at least two cables strung parallel with the rows of posts;
a plurality of guides of claim 1, each of the guides attached to a respective one of the posts, and drawing together and holding the at least two cables.
